(19) United States
(12) Patent Application Publication
(10) Pub. No.: US 2024/0033965 A1
(43) Pub. Date: Feb. 1, 2024

(54) TREE FEEDING SYSTEM AND METHOD

(71) Applicant: Tigercat Industries Inc., Brantford (CA)

(72) Inventors: Shawn Thomas PETTE, Brantford (CA); Duane Anthony Barlow, Brantford (CA); Nathan William Daniel Henry, Brantford (CA); Mitchell James Sam Terpstra, Brantford (CA)

(21) Appl. No.: 18/227,780

(22) Filed: Jul. 28, 2023

Related U.S. Application Data
(60) Provisional application No. 63/393,019, filed on Jul. 28, 2022.

(51) Int. Cl. B27B 25/02

(52) U.S. Cl. CPC B27B 25/02

(57) ABSTRACT

In one embodiment, there is provided a tree feeding system for use with tree handling equipment, the tree feeding system including: a housing having a frame and at least one arm; a plurality of tree feeding wheels arranged with at least one wheel on the frame and at least one wheel on the at least one arm; and a hydraulic circuit for driving the tree feeding wheels, wherein the hydraulic circuit is configured such that wheels on the frame are driven in series and wheels on the arm are driven in series. In another embodiment, the hydraulic circuit is configured such that wheels on one side (e.g. left hand side) of the housing are driven in series and wheels on an opposite side (e.g. right hand side) of the housing are driven in series but wheels on the frame are mechanically connected by a universal joint.

### CROSS-REFERENCE TO RELATED APPLICATION

This current application claims priority from U.S. Provisional Patent Application No. 63/393,019, filed Jul. 28, 2022, which is hereby incorporated by reference.

### TECHNICAL FIELD

The present disclosure relates generally to tree feeding hydraulic and mechanical systems for a tree handling device, and in particular to tree feeding systems and methods employing multiple hydraulically driven tree feeding wheels.

### BACKGROUND

In the forestry industry, harvesting trees involves felling the trees and one or more steps of processing to remove limbs, remove bark, and cut to merchandisable lengths. Various machines and devices are used to achieve these tasks. For one or more steps of processing, a common method of moving the tree through the device uses hydraulically driven tree feeding wheels in contact with the tree and configured with grips on the rolling surface to minimize slippage while also minimizing fibre damage. It is also known that a device with more wheels can improve grip for more effective and productive tree feeding and typically with reduced fibre damage compared to a device with fewer tree feeding wheels, particularly if the multiple wheels can effectively maintain positive contact with the tree.

One type of tree handling device is a tree harvesting or tree processing head, which is well known in the industry. Hydraulically driven feed wheels are typically used to grip and feed trees through the head. Harvesting heads are designed to maximize the production of processed trees by having high available feed force (force required to feed the tree through the head) and feed speed (how quickly a tree can be fed through the head). Harvesting heads are often provided with four feeding wheels to provide improved grip and extra power (higher feed force) to feed large trees or multiple smaller trees through the harvesting head. In conventional harvesting heads, there can be issues, particularly in a four-wheel situation, when one or more wheels lose contact with a tree being processed and the wheel ends up spinning freely (wheel slippage). In this situation, there can be wasted power, additional wear on components, loss of production, and potentially costly damage to the tree if the wheel spins when it suddenly regains contact.

Harvesting heads having four wheels will generally have two wheels (the two frame wheels) coupled together by using interlocking cogs/gears bolted to, welded to, or cut into these wheels in order to keep the wheels rotating at the same speed to reduce or prevent the power waste (and loss of production) of wheel slippage. However, this approach can lead to wear of the cogs/gear teeth due to high torque transfer and the effects of abrasive wear from the environment. This approach can also put more stress on feed motors and a supporting chassis for the coupled wheels because of high axial loading from the cogs/gear teeth.

As such there is a need for an improved system and method of controlling feed wheels in a tree handling device. Embodiments of the system and method described herein are intended to address at least one of the issues with conventional feed wheels in forestry equipment.

### SUMMARY OF PARTICULAR EMBODIMENTS

It will be appreciated by those skilled in the art that other variations of the embodiments described below may also be practiced without departing from the scope of the invention. Further note, these embodiments, and other embodiments of the present invention will become more fully apparent from a review of the description and claims which follow.

In a first aspect, the present disclosure provides a tree feeding system for tree handling equipment, the tree feeding system including: a housing having a frame and at least one arm; a plurality of tree feeding wheels arranged with at least one wheel on the frame and at least one wheel on the at least one arm; and a hydraulic circuit for driving the tree feeding wheels, wherein the hydraulic circuit is configured such that wheels on the frame are driven in series and wheels on the arm are driven in series.

In some embodiments, each series circuit is controlled by a separate directional control valve. In some cases, each directional control valve may include a free-wheeling setting.

In some embodiments, each series circuit may include a torque control valve.

In another aspect, the present disclosure provides a method of feeding trees in tree handling equipment, the method including arranging a hydraulic circuit for driving tree feeding wheels such that tree feeding wheels on a frame are driven in series and tree feeding wheels on an arm are driven in series.

In another aspect, there is provided a tree feeding system for tree handling equipment, the tree feeding system including: a housing having a frame and at least one arm; a plurality of tree feeding wheels arranged with at least one wheel on the frame and at least one wheel on the at least one arm; and a hydraulic circuit for driving the tree feeding wheels, wherein the hydraulic circuit is configured such that wheels on one side (e.g. left hand side) of the housing are driven in series and wheels on an opposite side (e.g. right hand side) of the housing are driven in series but wheels on the frame are mechanically connected by a universal joint.

Other aspects and features of the present disclosure will become apparent to those ordinarily skilled in the art upon review of the following description of embodiments in conjunction with the accompanying figures.

### BRIEF DESCRIPTION OF THE DRAWINGS

Various aspects of at least one example are discussed below with reference to the accompanying figures, which are not intended to be drawn to scale. The figures are included to provide an illustration and a further understanding of the various aspects and examples, and are incorporated in and constitute a part of this specification, but are not intended as a definition of the limits of a particular example. The drawings, together with the remainder of the specification, serve to explain principles and operations of the described and claimed aspects and examples. In the figures, each identical or nearly identical component that is illustrated in various figures is represented by a like numeral. For purposes of clarity, not every component may be labeled in every figure. In the drawings:

FIG. 1 illustrates an embodiment of a tree handling system (harvesting head) showing the feed wheels;

FIG. 2 is a schematic representation of feed wheels in contact with a tree or log;

FIG. 3 is a schematic representation of the feed wheels when there is poor contact with a tree or log;

FIG. 4 is another schematic representation of the feed wheels when there is poor contact with a tree or log;

FIG. 5 is a schematic representation of an embodiment of a hydraulic circuit for wheel feed motors in a tree handling system;

FIG. 6 illustrates the hydraulic circuit of FIG. 5 with flow divider valves;

FIG. 7 is a schematic representation of an embodiment of cogged feed wheels;

FIG. 8 is a schematic representation of another embodiment of a hydraulic circuit with mechanically linked feed wheels;

FIG. 9A illustrates an embodiment of feed wheels for a harvesting head;

FIG. 9B is a section view of the embodiment of FIG. 9A in which the wheels are sectioned;

FIG. 9C shows the embodiment of FIG. 9A without the wheels;

FIG. 10 is a schematic representation of a further embodiment of a hydraulic circuit;

FIG. 11A is a schematic representation of a further embodiment of a hydraulic circuit;

FIG. 11B is a schematic representation of a further embodiment of a hydraulic circuit;

FIG. 12 is a schematic representation of a further embodiment of a hydraulic circuit;

FIG. 13 is a schematic representation of a further embodiment of a hydraulic circuit; and

FIG. 14 is a block diagram of a control system according to an embodiment.

### DETAILED DESCRIPTION OF PARTICULAR EMBODIMENTS

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

References in the specification to “one embodiment”, “an embodiment”, “a preferred embodiment”, “an alternative embodiment”, “embodiments”, “variations”, “a variation” and similar phrases mean that a particular feature, structure, or characteristic described in connection with the embodiment(s) or variation(s) is included in at least an embodiment or variation of the invention. The appearances of the phrase “in one embodiment” or “in one variation” in various places in the specification are not necessarily all referring to the same embodiment or variation.

The term “couple”, “coupled”, “connected”, “joined”, “attached” or “fixed” as used in this specification and the appended claims refers to either an indirect or direct connection between the identified elements, components or objects. Often the manner of the coupling will be related specifically to the manner in which the two coupled elements interact.

The term “or” as used in this specification and appended claims is not meant to be exclusive rather the term is inclusive meaning “either or both”.

Generally, there is provided a system and method for controlling feed wheels in forestry equipment and, more particularly, a system and method for controlling feed wheels in a harvesting head.

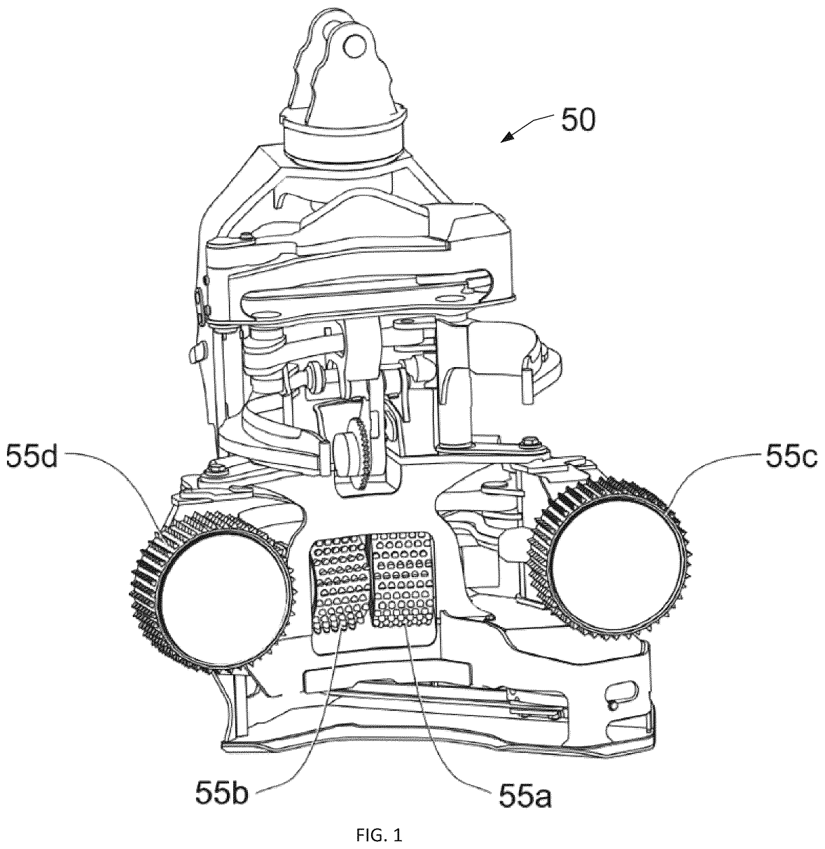

FIG. 1 shows an embodiment of a tree handling system 50 as applied to a harvesting head. The tree handling system 50 includes four feed wheels 55. The four feed wheels 55, include a right hand frame wheel 55a, a left hand frame wheel 55b, a right hand arm wheel 55c and a left hand arm wheel 55d. The feed wheels hold and move a tree/log or the like (hereafter referred to as “tree”) through the tree handling system 50. In this case, the tree handling system is a harvesting head but it will be understood that embodiments herein may be applied to other equipment where trees are feed using feed wheels. It will also be understood that the harvesting head or other equipment may also generally include arms for holding the tree, a cutting mechanism for cutting the tree or the like. In this description, the terms right hand (RH) and left hand (LH) are used when looking at the front of the harvesting head. When a harvesting head is in operation, the terms right hand (RH) and left hand (LH) may be different as these terms are sometimes used to refer to the view from the back of the harvesting head (i.e. from an operator's cabin or the like). One of skill in the art will understand the intended meaning of these terms in context.

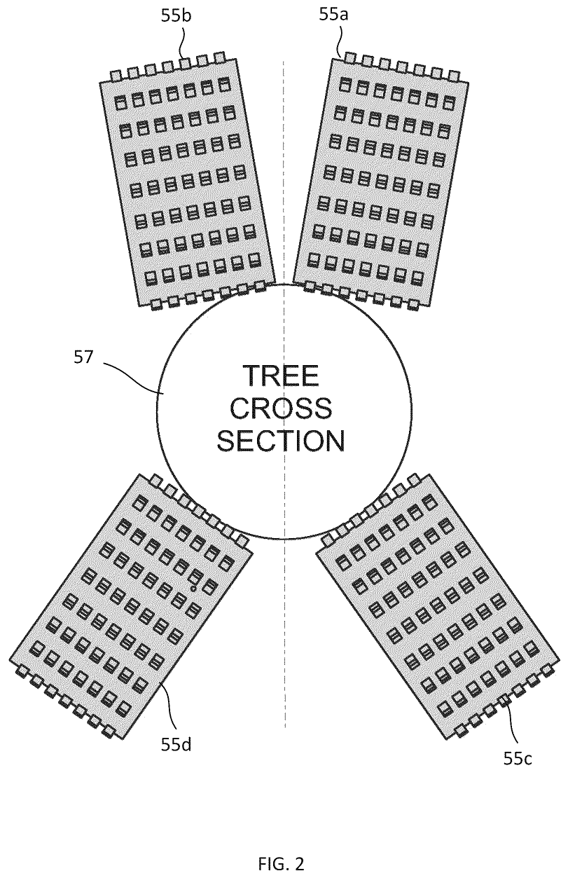

FIG. 2 is a schematic representation of the feed wheels 55 when in contact with the tree 57. In this illustration, the tree contact is such that all four wheels 55 are contacting the tree 57. Four wheeled harvesting heads generally provide greater grip and extra power to feed larger trees. The type of contact illustrated allows for maximum horsepower of feed wheel motors to be provided to the feed wheels 55 and then applied to the tree 57.

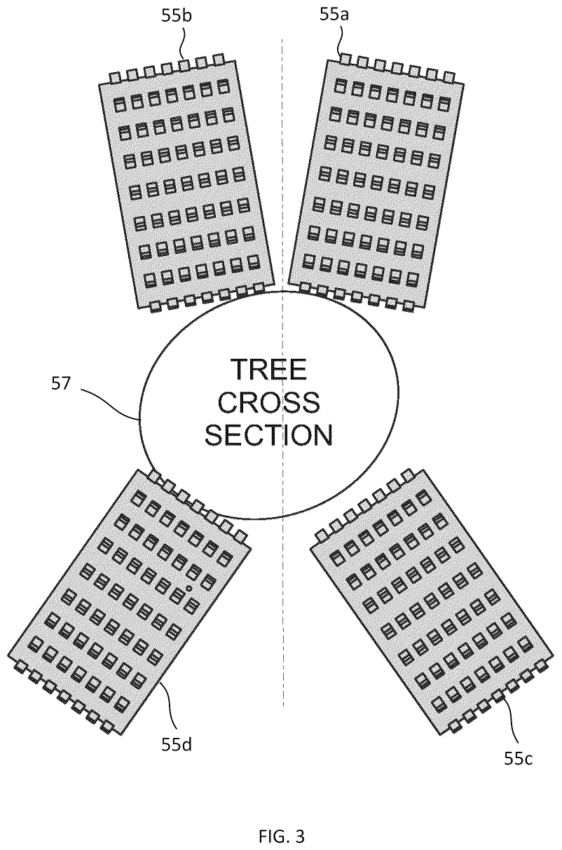

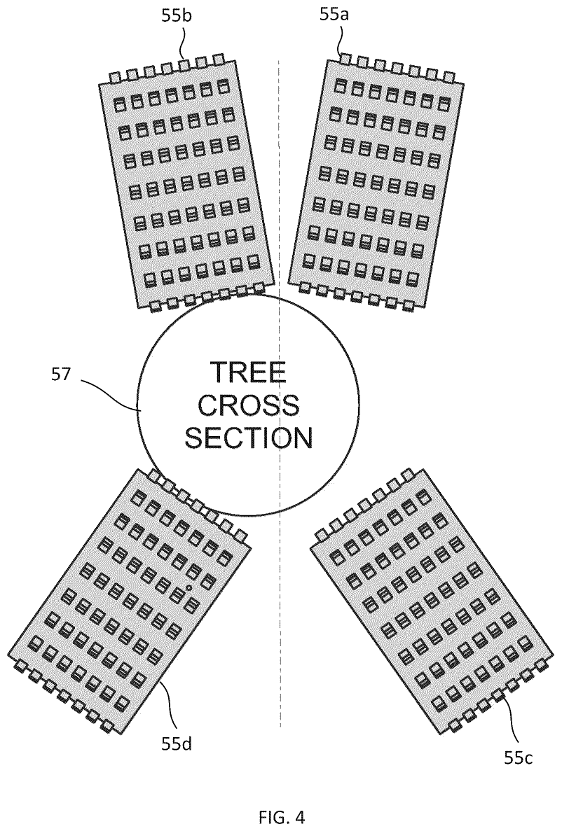

FIGS. 3 and 4 are schematic representations of the feed wheels 55 when there is poor contact with a tree 57 (in FIG. 3, the right-hand (RH) arm wheel 55c has lost contact, in FIG. 4, both RH wheels 55a, 55c have lost contact). Poor tree contact can occur quite frequently when processing logs/trees due to various factors including crooked, multi-stem, varying diameter trees, or the like. As noted above, in a poor contact situation, one or more feed wheels 55 may have limited contact with the tree 57 and slip or lose contact with the tree 57 and spin freely. This situation can result in wasting power as the power may be directed to a freely spinning wheel instead of being transmitted to the tree 57. This situation can also result in wearing of components, loss of production, tree damage, and the like. In some cases, the feed wheels 55 may lose contact for a varying (i.e. longer or shorter) period of time due to changes in the shape of the tree 57 and the like. Because of the quickly changing conditions, it can be difficult to implement a control system to deal with the changing power needs at each wheel in real-time.

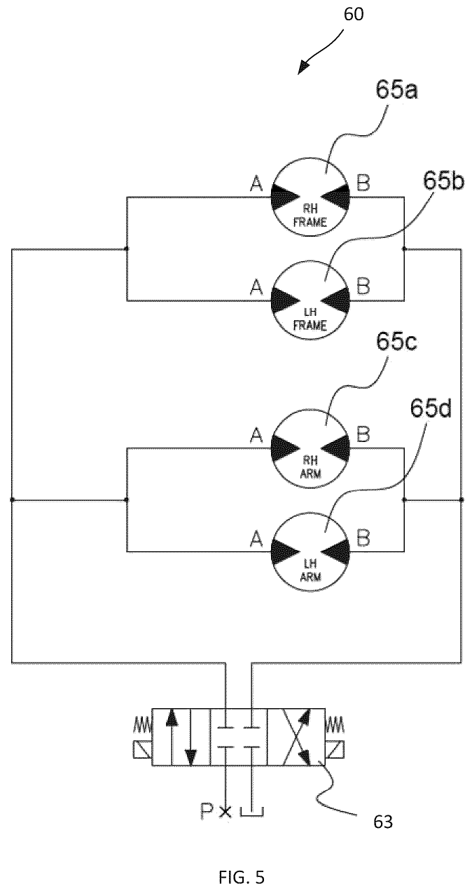

FIG. 5 is a schematic diagram of an example hydraulic circuit 60 for a tree handling system. In the hydraulic circuit 60, a directional control valve (DCV) 63 controls the feed direction. Each wheel feed motor (RH frame wheel feed motor 65a, LH frame wheel feed motor 65b, RH arm wheel feed motor 65c, & LH arm wheel feed motor 65d) is hydraulically connected in a parallel arrangement (i.e. each wheel will have independent flowrates).

This circuit 60 will generally apply higher feed force but slower feed speed than other configurations described herein. However, the circuit 60 has inherent slippage issues, as all four wheels 55 need to maintain contact to transmit full power to the tree 57.

In a situation of poor tree contact (as in FIG. 3) with the hydraulic circuit of FIG. 5 there will be reduced or no contact between the RH arm wheel 55c and the tree. In this situation, the RH arm wheel feed motor will continue to rotate the wheel and consume power. Additionally, the wheel 55c (no contact) can rotate at high velocity and potentially damage tree fibers when it regains contact or touches the tree 57 in some way.

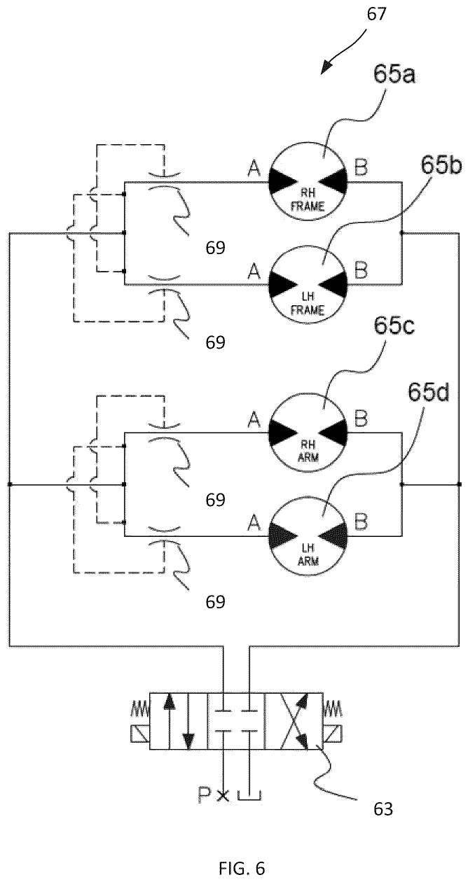

FIG. 6 is a schematic of another example hydraulic circuit 67 that is similar to that of FIG. 5. In FIG. 6, flow divider valves 69 are provided upstream of each motor pair. The flow divider valves are configured to divide hydraulic flow equally within each pair of wheel motors. This arrangement limits the velocity of a wheel with no contact and, as such, is intended to reduce the chance of tree damage when the wheel with no contact regains contact.

In a situation with poor tree contact (as in FIG. 3) with the hydraulic circuit of FIG. 6, there will be a pressure drop across the RH arm wheel flow divider valve as it limits hydraulic flow. However, when one or more wheels lose contact with the tree using the hydraulic circuits of FIG. 5 or FIG. 6, this will result in wasted horsepower and can cause high component wear. Overall, there will be less force transmitted to the tree and thus lower overall harvesting head performance.

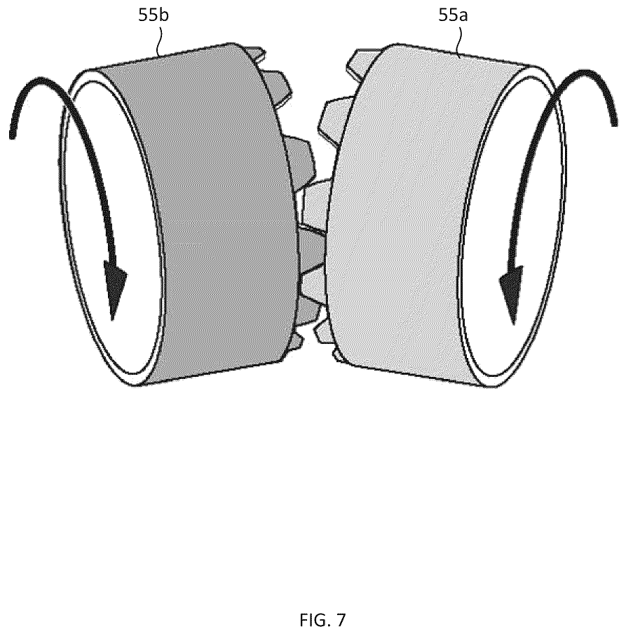

In order to overcome at least some of the issues with wasted power when contact is lost, at least some conventional tree harvesters, especially four-wheel feed motor units, mechanically couple the two frame wheels 55a, 55b together by using interlocking cogs or gear teeth bolted to, welded to, or cut into the frame wheels 55a, 55b (illustrated in FIG. 7). This causes the two frame wheels 55a, 55b to rotate together (i.e. at the same rate) even if one wheel loses contact with the tree. However, due to the harsh and abrasive environment and the high torque transfer involved in this type of equipment, there can be high wear on the cogs/gear teeth. Further, in at least some cases, the high axial loading caused by the pressure angle of the cogs/gear teeth can also be very tough on the feed motors and related chassis.

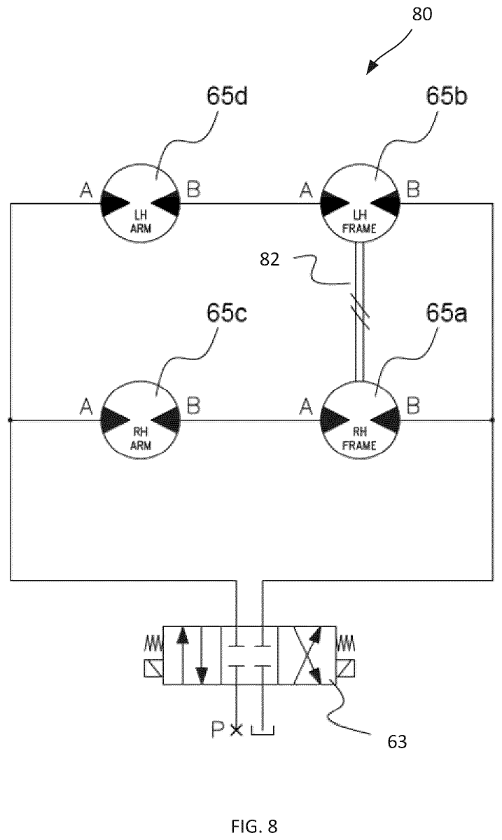

FIG. 8 illustrates an embodiment of a hydraulic circuit 80 for a harvesting head in which the frame wheels are coupled with a mechanical linkage 82. In this hydraulic circuit, the LH arm and frame wheel feed motors (65d, 65b) are hydraulically linked in a series arrangement and the RH arm and frame wheel feed motors (65c, 65a) are hydraulically linked in a series arrangement. This hydraulic circuit 80 provides a lower feed force but higher feed speed than the hydraulic circuit 60 of FIG. 5. This hydraulic circuit 80 can be used primarily for its anti-slip capabilities. As noted, the hydraulic circuit 80 is typically used with cogs or gears providing a mechanical link between frame wheels but any appropriate mechanical linkage can be used.

When there is poor tree contact (as in FIG. 3), the hydraulic circuit of FIG. 8 distributes power to the three wheels in contact with the tree and the hydraulic pressure bypasses the, for example, RH arm wheel feed motor and goes straight to the RH frame wheel feed motor. In the case where both RH wheels lose contact (as in FIG. 4), power from the RH frame wheel motor is then transferred mechanically to the LH frame wheel to be transferred to the tree. As such, essentially all force can be transmitted to the tree through the remaining wheels in contact.

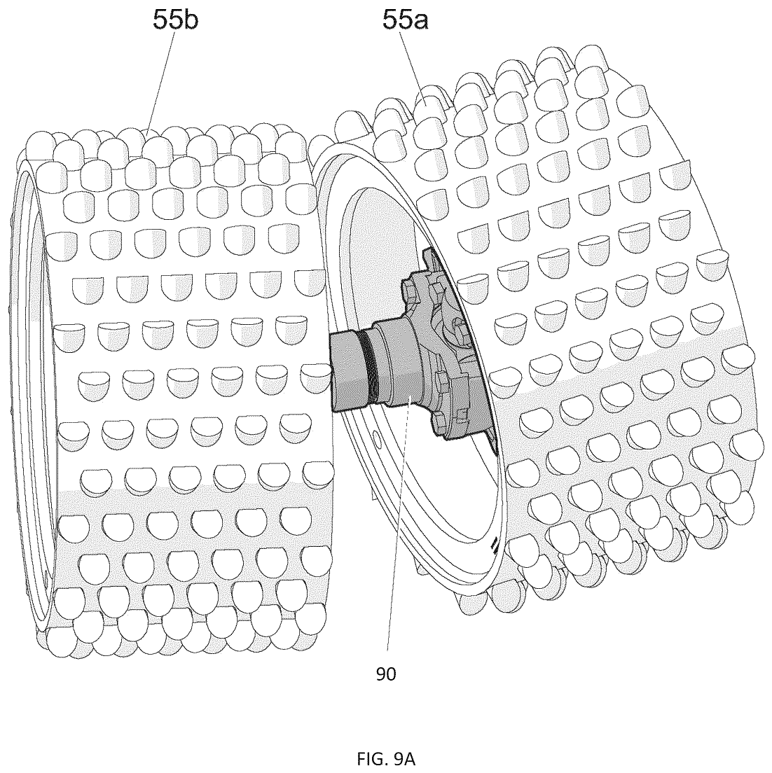

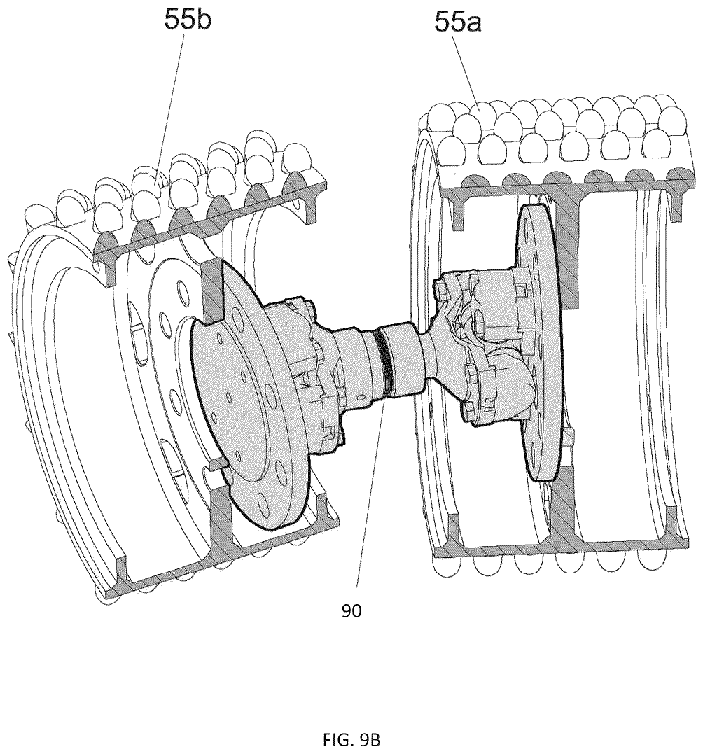

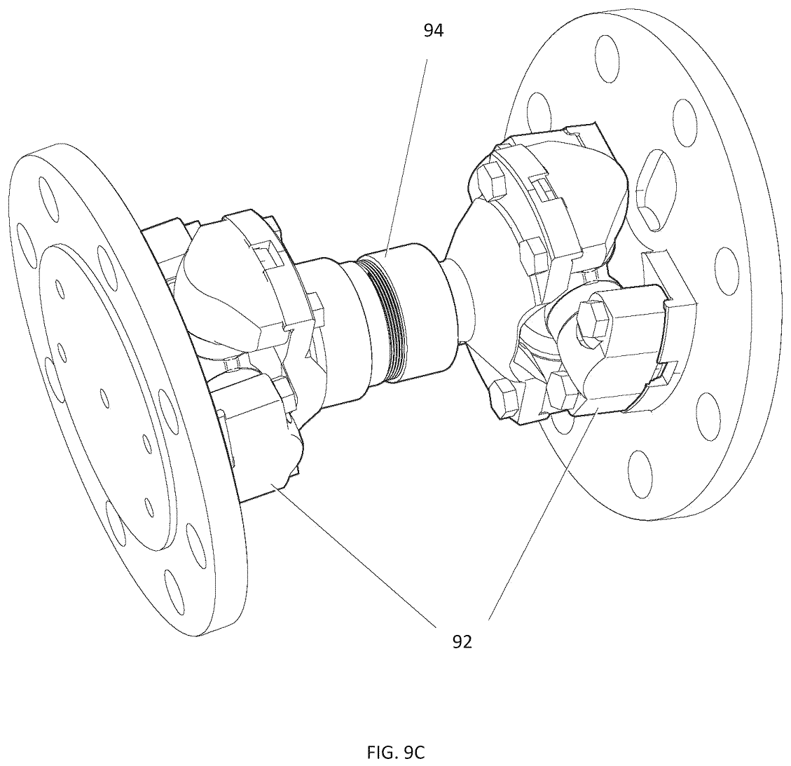

FIGS. 9A, 9B and 9C illustrate another embodiment of a system for controlling the feed wheels for a harvesting head. As shown in FIGS. 9A, 9B, and 9C, the frame wheels (55a & 55b) are mechanically connected by a universal joint coupler 90. The universal joint coupler mechanically locks the frame wheels together using two universal joints (U-joints) 92 and a splined slip shaft 94 (illustrated in FIG. 9C). The U-joints transmit torque between the wheels and accommodate misaligned shafts while providing minimal axial loading. Further, since the universal joint coupler can have enclosed wearing surfaces, the wearing surfaces can be lubricated and sealed against contaminants in order to reduce wear. This lubrication and low axial loading can contribute to increased mechanical efficiency (less wasted horsepower) and improved component life versus cogs or gear teeth solutions. When combined with the hydraulic circuit of FIG. 8, the feed wheels can be controlled for better contact with the tree.

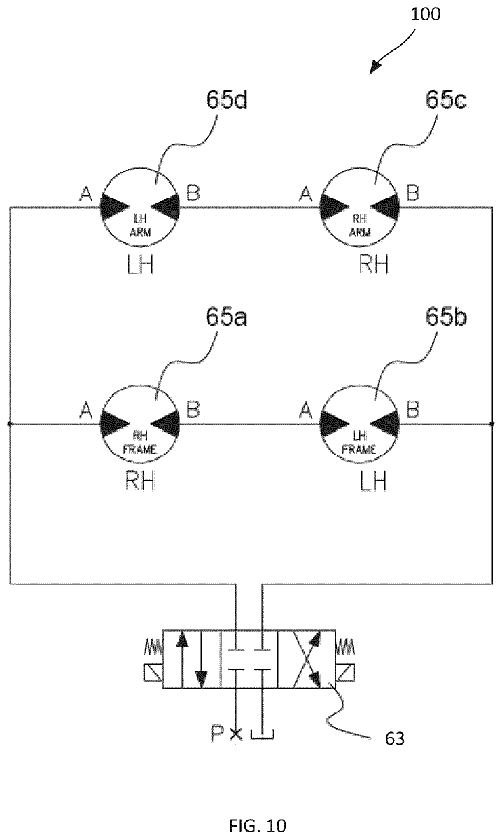

FIG. 10 illustrates a hydraulic circuit 100 according to a further embodiment herein. In this hydraulic circuit (sometimes referred to as Anti Slip Arrangement: Novel Full-Time 4WD), the arm wheel feed motors (65c & 65d) are hydraulically linked in a series arrangement and the frame wheel feed motors (65a & 65b) are hydraulically linked in a series arrangement. With the hydraulic circuit 100 of FIG. 10, it is not necessary to have a mechanical linkage between the frame wheels. While the series arrangement of the motors may be less efficient than the parallel arrangement of the hydraulic circuit 60 shown in FIG. 5, the hydraulic circuit 100 of FIG. 10 can provide more power to a tree in a situation when there is intermittent poor contact of the wheels with the tree 57. This anti-slip hydraulic circuit 100 can provide a lower feed force than the circuit of FIG. 5 but a higher feed force than the hydraulic circuit 80 of FIG. 8. The feed speed will generally be higher than the hydraulic circuit 60 of FIG. 5 and comparable to the hydraulic circuit of FIG. 8. In the arrangement of FIG. 10, the configuration can have opposing wheel motors leading and trailing respectively, so primary motive force is more balanced.

In the hydraulic circuit 100 of FIG. 10, when there is poor tree contact, the hydraulic circuit 100 will allow for use of full hydraulic power as long as one each of the frame/arm wheels stay in contact. For example, if both RH wheels 55a, 55c lose contact with the tree 57, only the LH motors 65d will consume hydraulic power and transfer power to the tree 57. With no applied load, both RH motors 65b, 65d will develop minimal pressure drop (resulting in minimal power consumption). In this way, essentially full hydraulic power is transmitted to the LH wheel feed motors 65b, 65d and the force can be transmitted to the tree 57 through the LH wheels 55b, 55d remaining in contact.

As shown in FIG. 10, each pair of arm wheel feed motor and frame wheel feed motor are connected in parallel (i.e. LH arm motor 65d and LH frame motor 65b are in parallel and RH arm motor 65c and RH frame motor 65a are in parallel), which allows for more efficient two wheel drive (for example, when just the arm wheels are in contact) as compared to the hydraulic circuit shown in FIG. 8. Additionally, in the hydraulic circuit 100 of FIG. 10, arm wheel feed motors 65d and frame wheel feed motors 65a, 65b can be sized independently and no matching of displacements relative to different wheel sizes is required. Generally speaking, RH and LH arm wheels 55c, 55d are the same diameter and RH and LH frame wheels 55a, 55b are virtually always the same diameter, but frame wheels are usually a smaller diameter than arm wheels. Conversely, the hydraulic circuit 80 of FIG. 8 would generally require using different displacement feed motors (at the cost of hydraulic efficiency) to try to match flows. Additionally, in the hydraulic circuit 100 of FIG. 10, opposite side frame motors (i.e. LH arm motor 65d and RH frame motor 65a) are configured to lead in the layout to aid in providing balanced loading on the tree.

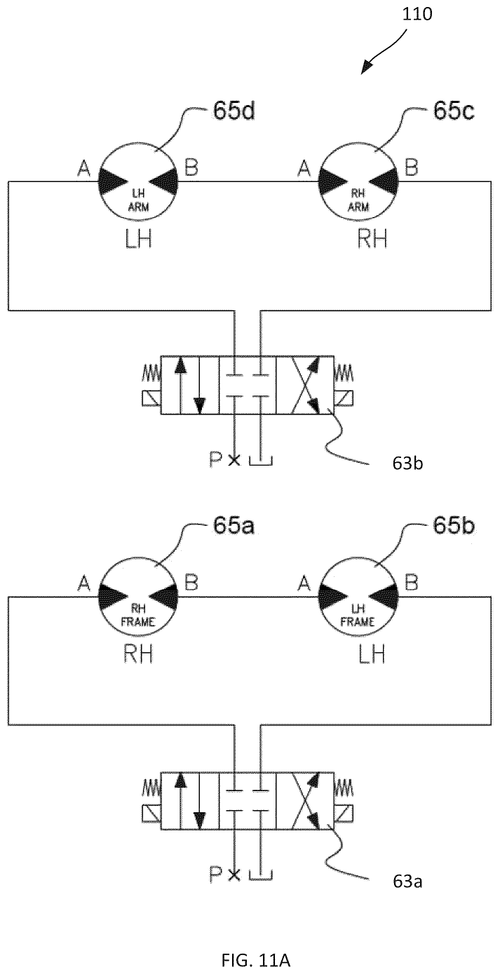

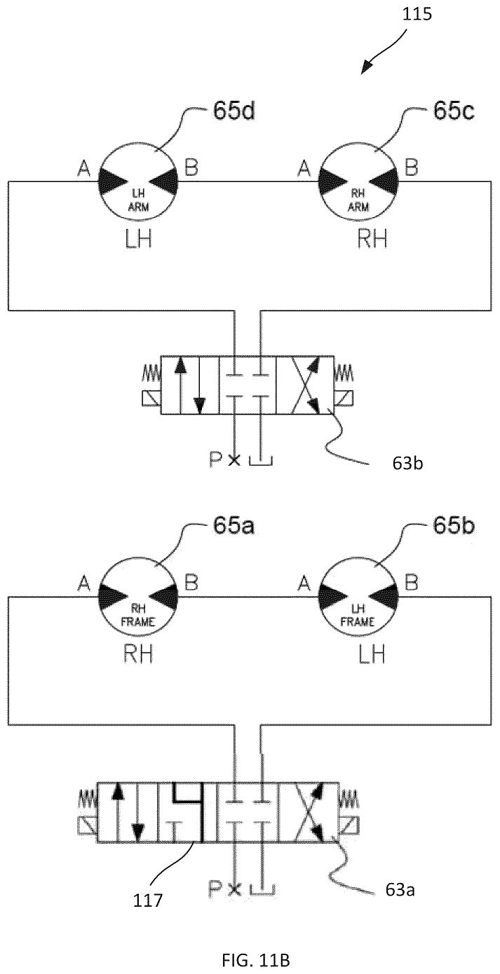

FIG. 11A illustrates a further embodiment of a hydraulic circuit 110. The hydraulic circuit 110 is similar to the hydraulic circuit 100 of FIG. 10 but is provided with two directional control valves (DCVs) 63a, 63b, one for each series circuit. The independent DCVs can be used to limit flow to each circuit and prevent one circuit from receiving the full flow in a limited traction situation.

FIG. 11B illustrates a further embodiment of a hydraulic circuit 115. The hydraulic circuit 115 is similar to the hydraulic circuit 110 of FIG. 11A but is provided with an additional float (or free-wheeling) valve position 117 on the DCV 63a. The float function can be generally similar to that described in Canadian Patent No. CA2550127, granted on May 12, 2009, and owned by Tigercat Industries Inc. It will be understood that various valving arrangements could be used for each of the DCV valves in the various embodiments. The schematic of the DCV 63a, as shown in FIG. 11B, provides forward & reverse feeding, braking and float (free-wheeling) and could be used in other embodiments herein, where appropriate. It is noted that the arrangement of arm motors in series and frame motors in series is expected to maintain anti-slip of both arm and frame wheels whether driving or free-wheeling.

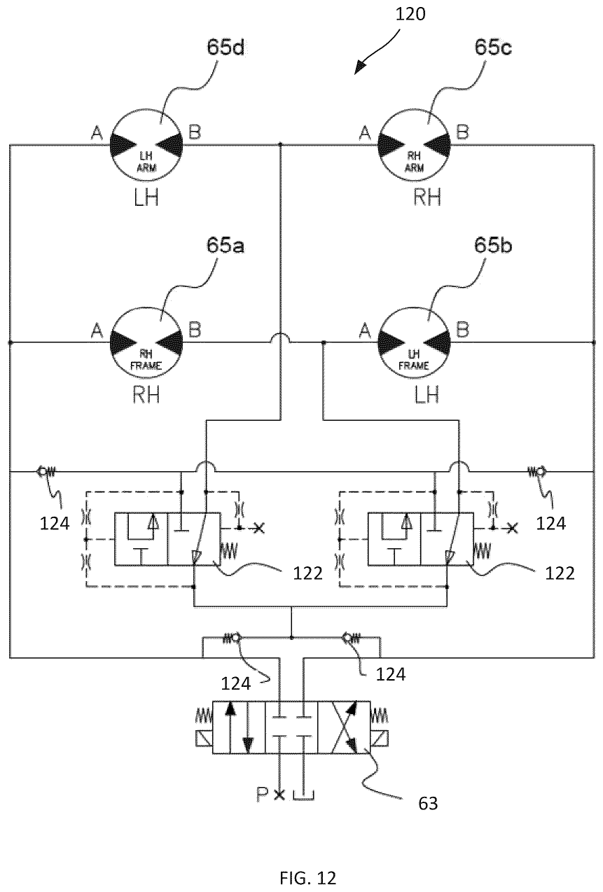

FIG. 12 illustrates a further embodiment of a hydraulic circuit 120 wherein a torque-divider valve 122 is added to each series circuit. Check valves 124 can also be added to allow for operation of motors in both forward and reverse directions. The torque-divider valves 122 can be used to balance the torque and wheel feed force in each pair of motors. The balancing can be achieved except during high-slip conditions (i.e. when one or more wheels are not in contact with the tree). In high slip conditions, nearly full torque will be applied to the wheel with best contact. Under normal (e.g. minimal slip) drive conditions, the tree feeding is more consistent (tree stays centered on the head). The ability to have balanced loading between motors equalizes component wear and equalizes grip contact on the tree to reduce tree fiber damage. As noted above, having opposite motors as the first motor on the serial branches also helps to balance loading on the tree.

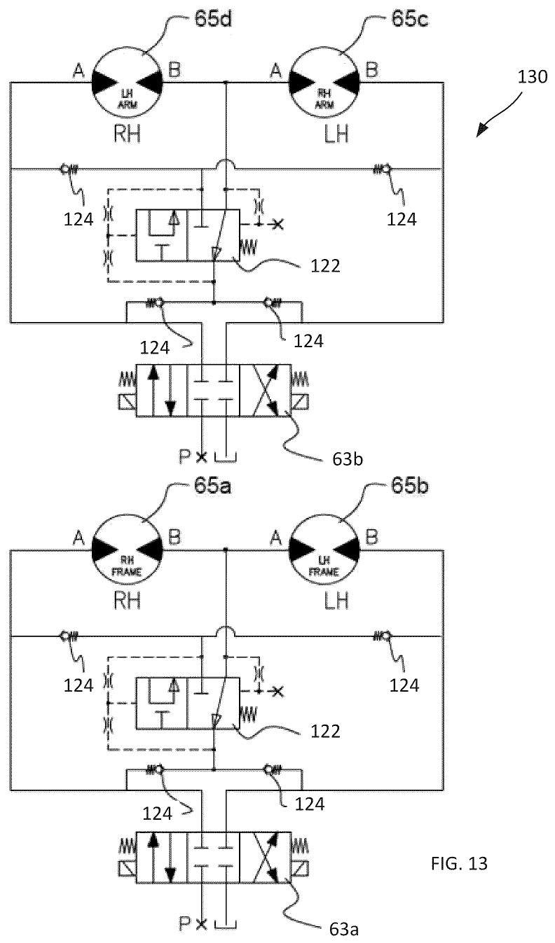

FIG. 13 illustrates a further embodiment of a hydraulic circuit 130, which is similar to the hydraulic circuit 120 of FIG. 12. The hydraulic circuit 130 further includes two directional control valves (DCVs) 63a, 63b, one for each series circuit (similar to the hydraulic circuit 110 of FIG. 11). As noted above, the independent DCVs can be used to limit flow to each circuit and prevent one circuit from receiving the full flow in a limited traction situation.

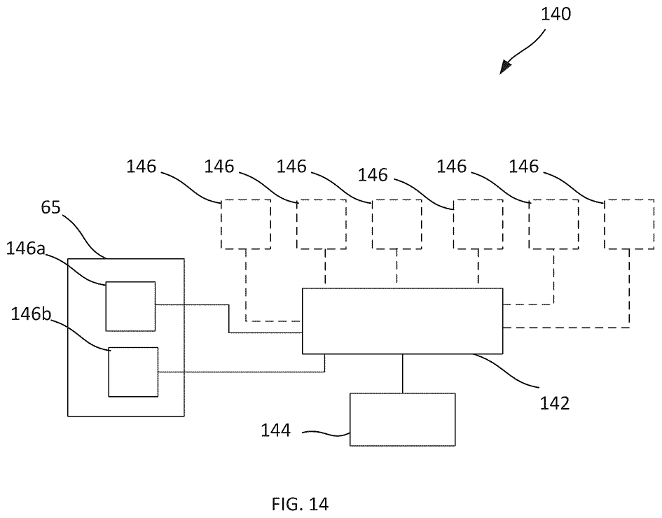

FIG. 14 is a block diagram of an embodiment of a control system 140 for controlling the tree handling system 50. The control system 140 includes a computerized control 142 (sometimes referred to as a processor) and a hydraulic interface 144. The hydraulic interface 144 may be a part of the computerized control or a separate element and is a known system providing for communication between the processor and the hydraulic circuits and related hydraulic control valves referred to above. The computerized control 142 may include input from one or more sensors 146 such as motor speed sensors, wheel speed sensors, tree feed speed sensors, pressure sensors, and the like. For example, each hydraulic motor 65 may be provided with a motor speed sensor 146a and a motor pressure sensor 146b or the like. There may also be sensors to determine tree diameter, feed speed, length, and the like. The sensors 146 can provide data to the computerized controller 142 to allow the computerized controller to adjust the hydraulic circuit (via the hydraulic interface 144) to more closely match the flows within each hydraulic circuit embodiment to further limit slippage. The computerized control 142 can also include a user interface to allow input from a user of the equipment to configure and/or use the various hydraulic circuits described herein. In some embodiments, the system can be configured such that a user can choose between various circuits depending on the needs of the equipment. The computerized control 142 can be used to implement the control methods described herein by having a processor execute computer readable code to adjust the hydraulic circuits based on the sensor input.

It will be understood that the overall configuration of the control system may vary. For example, the computerized control may be in the cabin with wires routed to the hydraulic interface (hydraulic head) and/or control valves and sensors. In other cases, the computerized control can be distributed, with processors at different points. Further communication may be wireless as an alternative to or in addition to wired.

Generally, the embodiments herein can be optimized by sizing arm wheel feed motors to provide a higher percentage of feed force vs the frame wheels (because arm wheels tend to have more positive contact with the tree). Differential sizing of these motors and of the wheel diameters may also be beneficial in debarking applications where a difference in wheel speeds can more effectively remove bark from the tree being processed. In each of the embodiments herein, it is also possible to provide a two-speed motor at some or all of the motors. The use of two-speed motors can improve processing efficiency by using higher speed for processing smaller trees, where lower feed force is needed, while allowing for maximum feed force at slower speeds for larger trees. With the ability to independently size arm motor and frame motor sizes/displacements, and arm and frame wheel diameters, it is possible to have near limitless ratios of speed and torque for a two speed arrangement. Further, using a torque divider such as in FIG. 12 in various embodiments can further balance left/right torque to maintain near equal force on the tree.

In the preceding description, for purposes of explanation, numerous details are set forth in order to provide a thorough understanding of the embodiments. However, it will be apparent to one skilled in the art that these specific details may not be required. It will also be understood that aspects of each embodiment may be used with other embodiments even if not specifically described therein. Further, some embodiments may include aspects that are not required for their operation but may be preferred in certain applications. In other instances, well-known structures may be shown in block diagram form in order not to obscure the understanding. For example, specific details are not provided as to whether the embodiments described herein are implemented as a software routine, hardware circuit, firmware, or a combination thereof.

Embodiments of the disclosure or elements thereof can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with other modules and elements, including circuitry or the like, to perform the described tasks.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, functions, operations, or steps, any of these embodiments may include any modification, combination or permutation of any of the components, elements, functions, operations, or steps described or illustrated anywhere herein that a person having ordinary skill in the art would comprehend. All such modifications, combinations and permutations are believed to be within the sphere and scope of the invention as defined by the claims appended hereto.

We claim:

1. The apparatuses, systems and methods as described generally in the preceding description.

2. The tree feeding apparatuses, systems and methods described in the preceding description.

3. Any other invention described in the preceding description.
